(19) United States
(12) Patent Application Publication
(10) Pub. No.: US 2016/0339388 A1
(43) Pub. Date: Nov. 24, 2016

(54) Volatile Organic Compound Removal System Using Microwaves

(71) Applicant: ECOPRO CO., LTD., Chungcheongbuk-do (KR)

(72) Inventors: Dong Che Lee, Cheongju-si (Chungcheongbuk-do) (KR); Seong Jin Yoon, Seoul (KR); Sung Jong Cho, Cheongju-si (Chungcheongbuk-do) (KR); Jeong Yeon Kim, Cheonan-si (Chungcheongnam-do) (KR); Sang Jun Park, Cheongju-si (Chungcheongbuk-do) (KR)

(73) Assignee: ECOPRO CO., LTD., Chungcheongbuk-do (KR)

(21) Appl. No.: 15/112,301

(22) PCT Filed: Oct. 6, 2014
(86) PCT No.: PCT/KR2014/009364

§ 371 Date: Jul. 18, 2016

(30) Foreign Application Priority Data
Jan. 22, 2014 (KR) 10-2014-0007496

(51) Int. Cl. B01D 53/86; B01D 53/75; B01D 53/04

(52) U.S. Cl. CPC B01D 53/8668; B01D 53/0438; B01D 53/75; B01D 2259/40094; B01D 2253/10; B01D 2253/3425; B01D 2253/25; B01D 2257/708; B01D 2255/70

(57) ABSTRACT

The present disclosure relates to a volatile organic compound removal system using microwaves, the system having a structure wherein an adsorption filter and an oxidation filter for oxidizing VOCs desorbed from the adsorption filter are arranged successively in a flow path of air containing VOCs, and the adsorption filter and the oxidation filter are respectively heated by using microwaves. The system includes: a first body part having first inlet and outlet, and the flow path therein; first adsorption filter and oxidation filter provided in the first body part and provided to allow gases flowing in the flow path to pass successively in the direction from the first inlet to outlet; and a plurality of first magnetrons provided at one side of the first body part to respectively correspond to the first adsorption filter and oxidation filter, and selectively irradiating microwaves to the first adsorption filter and oxidation filter.

### TECHNICAL FIELD

The present disclosure relates generally to a volatile organic compound removal system using microwaves. More particularly, the present disclosure relates to a volatile organic compound removal system using microwaves, the system having a structure in which an adsorption filter and an oxidation filter for oxidizing volatile organic compounds desorbed from the adsorption filter are arranged successively in a flow path of air that contains volatile organic compounds, and the adsorption filter and the oxidation filter are respectively heated by using microwaves.

### BACKGROUND ART

This section provides background information related to the present disclosure which is not necessarily prior art.

Generally, waste gas generated from a semiconductor producing process or a LCD manufacturing process is a mixture of volatile organic compounds (VOCs), perfluorinated compounds (PFCs), water, impurities such as particles, and additives in a PR (photo resist) process, such as butyl acetate and 2-ethoxyethyle acetate, etc.

Volatile organic compounds are a hazard to human health and cause a respiratory disorders and cancer, etc. Further, such compounds contribute to environmental contamination by causing smog due to photochemical reaction, malodor, and increased ozone concentrations in a city.

A method for a treatment of volatile organic compounds emissions is classified into an activated carbon adsorption process, a catalytic thermal oxidation process, and a regenerative thermal oxidation process.

Recently, research on a hybrid system to overcome disadvantages of the above-mentioned processes has been conducted.

In the case of a conventional adsorption process using activated carbon and adsorption, pollutants form another phase during the process. Thus, there remain problems of secondary separating pollutants and recycling activated carbon is performed at a high cost.

Meanwhile, a regenerative thermal oxidation (RTO) process and a catalytic thermal oxidation (CTO) process require LNG or an additional heat source. Thus, there is a problem of decreasing economic efficiency due to significant energy consumption.

In recent years, adsorption/desorption technologies for a volatile organic compounds removal/recovery system by using microwaves have become alternatives to conventional methods for a treatment of volatile organic compounds and have been given much attention.

Dielectric heating by using microwaves can heat pollutants directly, and when the pollutants contain non-polar molecules in which microwaves have no effect thereon, there is an advantage of efficiently heating pollutants by using surrounding water.

In this regard, Korea Patent No. 2006-11580 (Feb. 3, 2006) discloses a volatile organic compounds adsorption/desorption device that desorbs volatile organic compounds adsorbed by microwaves, whereby the device has a condenser that condenses and stores desorbed volatile organic compounds, and has a microwave plasma generator that completely vaporizes condensed water.

However, there was a problem with low treatment capacity of the microwave plasma generator.

Further, Korea Patent No. 1323108 (Oct. 23, 2013) discloses a honeycomb rotor-type VOCs removal system that uses horizontally polarized microwave radiation. The system includes: a cylindrically-shaped honeycomb-type desorption rotor provided with an absorbent; an irradiator for irradiating microwaves to a regeneration area radially divided around an axis of rotation of the rotor in the same direction of a flow path, in which air containing volatile organic compounds flows, and for heating the air; an oxidation unit for oxidizing the air containing volatile organic compounds, which is desorbed from an adsorbent by heat caused from microwaves.

However, there was a need for an additional oxidation unit for treating VOCs desorbed from the rotor. Thus, problems still remain in this technology as in the conventional catalytic thermal oxidation methods and regenerative thermal oxidation methods.

### DISCLOSURE

### Technical Problem

Accordingly, the present disclosure has been made keeping in mind the above problems occurring in the related art, and, in one aspect, the present disclosure is intended to propose a volatile organic compounds removal system for energy saving in which an adsorption filter and an oxidation filter for oxidizing volatile organic compounds desorbed from the adsorption filter are successively arranged in a flow path of gases containing volatile organic compounds, and each of the adsorption filter and the oxidation filter is heated by microwaves.

### Technical Solution

In order to achieve the above object, according to one aspect of the present disclosure, there is provided a volatile organic compounds removal system using microwaves, the system including: a first body part having a first inlet and a first outlet, with a flow path formed therein; a first adsorption filter and a first oxidation filter provided in an interior of the first body part and provided to allow gases flowing in the flow path to pass successively in a direction from the first inlet to the first outlet; and a plurality of first magnetrons provided in a side of the first body part to respectively correspond to the first adsorption filter and the first oxidation filter, and selectively irradiating the first adsorption filter and the first oxidation filter with microwaves.

In the volatile organic compounds removal system using microwaves according to one aspect of the present disclosure, at least one of the first and the second adsorption filters and the first and the second oxidation filters may be made of a material containing silicon carbide (SiC) and may be provided with a filter base made of a porous member with a plurality of through holes that are formed in a direction of the flow path, and heated by microwaves.

In the volatile organic compounds removal system using microwaves according to one aspect of the present disclosure, the filter base may have a honeycomb structure having the plurality of through holes that are formed in the direction of the flow path.

In the volatile organic compounds removal system using microwaves according to one aspect of the present disclosure, the first and the second adsorption filters may be provided by an adsorbent applied on a surface of the filter base having the plurality of through holes.

In the volatile organic compounds removal system using microwaves according to one aspect of the present disclosure, the first and the second oxidation filters may be provided by an oxidation catalyst applied on a surface of the filter base having the plurality of through holes.

In the volatile organic compounds removal system using microwaves according to one aspect of the present disclosure, each of the first and the second adsorption filters and the first and the second oxidation filters may be formed in a plate shape having a predetermined thickness, and may be provided in a direction perpendicular to the flow path, and the microwaves may be irradiated from sides of the first and the second adsorption filters and the first and the second oxidation filters in directions perpendicular to the flow path.

In the volatile organic compounds removal system using microwaves according to one aspect of the present disclosure wherein at least one of the first and the second adsorption filters and the first and the second oxidation filters may be provided as a plurality of filters that may be arranged successively at a predetermined interval.

In the volatile organic compounds removal system using microwaves according to one aspect of the present disclosure, an insulator may be provided between a downstream side of the first adsorption filter and an upstream side of the first oxidation filter in a direction from the first inlet towards the first outlet or between a downstream side of the second adsorption filter and an upstream side of the second oxidation filter in a direction from the second inlet towards the second outlet.

In another aspect of the present disclosure, the volatile organic removal system using microwaves may further include: a second body part provided independently of a first body part, and having a second inlet and a second outlet; a second adsorption filter and a second oxidation filter provided in an interior of the second body part and provided to allow the gases flowing in the flow path to pass successively in a direction from the second inlet to the second outlet; a plurality of second magnetrons provided in a side of the second body part to respectively correspond to the second adsorption filter and the second oxidation filter, and selectively irradiating the second adsorption filter and the second oxidation filter with microwaves; and a gas supply pipe provided to communicate with the first inlet and the second inlet, and having a valve unit that selectively controls gases containing volatile organic compounds to be supplied to the first body part or the second body part.

In the volatile organic removal system using microwaves according to another aspect of the present disclosure, the valve unit may sequentially repeat a first operation that supplies gases containing volatile organic compounds to the first body part and the second body part for a first predetermined time, a second operation that supplies gases containing volatile organic compounds to only the first body part for a second predetermined time, and a third operation that supplies gases containing volatile organic compounds to only the second body part for a third predetermined time.

In the volatile organic removal system using microwaves according to another aspect of the present disclosure, each of the plurality of second magnetrons may irradiate the second adsorption filter and the second oxidation filter with microwaves and a part of gases discharged via the first outlet may cool down the second magnetrons during the second operation, and each of the plurality of first magnetrons may irradiate the first adsorption filter and the first oxidation filter with microwaves and a part of gases discharged via the second outlet may cool down the first magnetrons during the third operation.

In the volatile organic removal system using microwaves according to another aspect of the present disclosure, the second predetermined time and the third predetermined time may be equal to or less than 30% of the first predetermined time.

In the volatile organic removal system using microwaves according to another aspect of the present disclosure, the first inlet and the second inlet may be respectively provided in lower parts of the first body part and the second body part in a direction of gravity, and the first outlet and the second outlet may be respectively provided in upper parts of the first body part and the second body part in the direction of gravity.

### Advantageous Effects

According to the present disclosure having the above-described characteristics, it is possible to propose a volatile organic removal system in which volatile organic compounds desorbed from a first adsorption filter are oxidized by a first oxidation filters successively provided in a first body part and therefore desorption and oxidation are performed sequentially inside the first body part. Thus, there is no need for addition of a conventional apparatus having low energy efficiency, such as RTO, RCO.

According to an embodiment of the volatile organic removal system using microwaves of the present disclosure, a contact area between gases containing volatile organic compounds and the first adsorption filter and the first oxidation filter is increased by a porous member having a plurality of through holes and therefore adsorption efficiency and oxidation efficiency of the filters are improved. Particularly, the honeycomb structure maximizes improvements of adsorption efficiency and oxidation efficiency of the filters and reduces pressure drop that may be caused by the plurality of through holes having intricate paths in the interior of the first body part.

According to the embodiment of the volatile organic removal system using microwaves of the present disclosure, a limitation of the heating temperature in the prior art can be solved by manufacturing the filter base having the plurality of through holes by using silicon carbide (SiC) and can be solved by manufacturing the adsorption filter and the oxidation filter by applying the adsorbent or the oxidation catalyst on the surface of the filter base having the plurality of through holes.

According to the embodiment of the volatile organic removal system using microwaves of the present disclosure, the second body part is provided independently of the first body part with the same structure as the first body part and therefore it is possible to enable sequential treatment of the gases containing volatile organic compounds.

### DESCRIPTION OF DRAWINGS

FIG. 1 is a view conceptually showing a first embodiment of a volatile organic compounds removal system using microwaves according to the present disclosure;

FIG. 2 is a view explaining desorption and oxidation in FIG. 1;

FIG. 3 is a view showing in detail an adsorption filter and an oxidation filter in FIG. 1;

FIG. 4 is a view conceptually showing a modification of FIG. 1; and

FIGS. 5 to 7 are views showing a second embodiment of a volatile organic compounds removal system using microwaves according to the present disclosure.

### MODE FOR INVENTION

Hereinbelow, a volatile organic compounds removal system using microwaves according to embodiments of the present disclosure will be described in detail with reference to the accompanying drawings.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

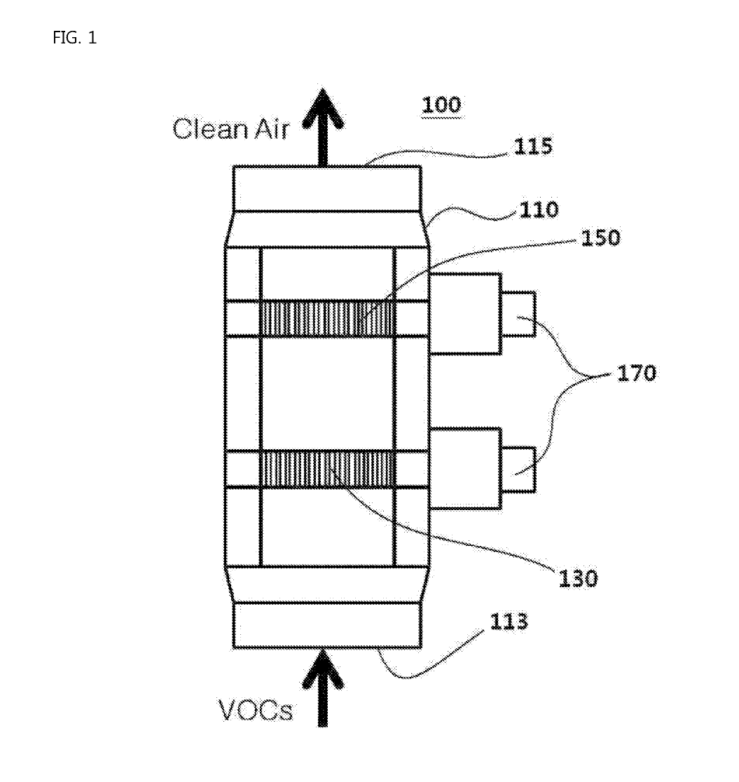

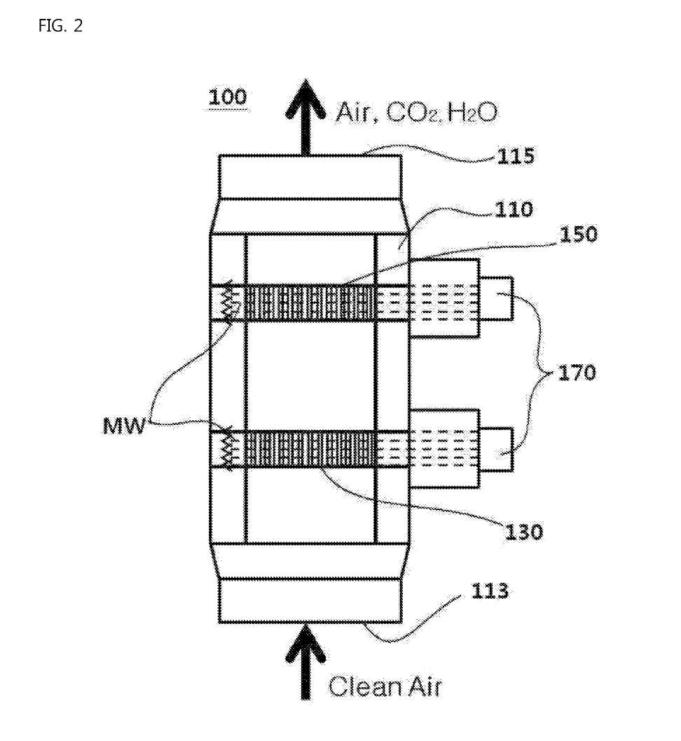

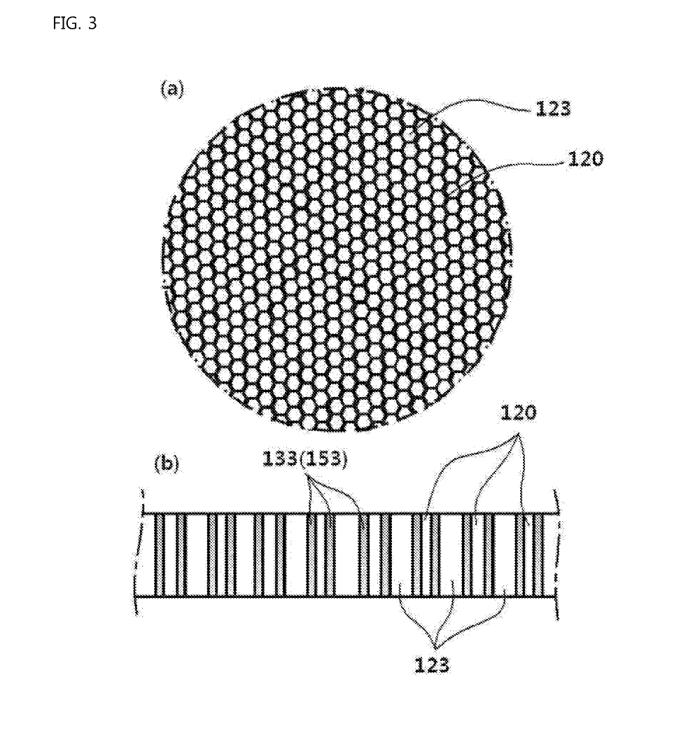

FIG. 1 is a view conceptually showing a first embodiment of a volatile organic compounds removal system using microwaves according to the present disclosure, FIG. 2 is a view explaining desorption and oxidation in FIG. 1, and FIG. 3 is a view showing in detail an adsorption filter and an oxidation filter in FIG. 1.

Referring to FIG. 1 to FIG. 3, the volatile organic compounds removal system 100 using microwaves according to the present embodiment includes: a body part 110, an absorption filter 130, an oxidation filter 150, and a plurality of magnetrons 170.

The body part 110 has an inlet 113 and outlet 115, and is a tubular shape having a flow path that communicates with the inlet 113 and the outlet 115. A cross-sectional shape of the body part is permissible in any type of shape including a circle, a square, and a polygon.

The adsorption filter 130 and the oxidation filter 150 are successively provided in the body part 110 in a flowing direction of VOCs gases that flow in the flow path inside the body part 110.

Here, the gases containing volatile organic compounds are introduced to the inlet 113, and reach the outlet 115 by successively passing the adsorption filter 130 and the oxidation filter 150.

The plurality of magnetrons 170 are provided in a side part of the body part 110 and are respectively provided at locations to correspond to sides of the adsorption filter 130 and the oxidation filter 150.

The plurality of magnetrons 170 heat the adsorption filter 130 and the oxidation filter 150 by selectively irradiating the adsorption filter 130 and the oxidation filter 150 with microwaves, thereby volatile organic compounds adsorbed by the adsorption filter 130 are desorbed, and desorbed volatile organic compounds are oxidized to discharge air, carbon dioxide, water vapor, etc. via the outlet 115.

In this regard, the volatile organic compounds desorbed from the adsorption filter 130 are oxidized by the oxidation filter 150 successively provided in the body part 110 and therefore desorption and oxidation are performed sequentially inside the body part 110. Thus, there is no need for a conventional apparatus having low energy efficiency, such as RTO, RCO. As a result, energy efficiency of the system 100 is improved.

Here, referring to FIG. 2, when concentration of the volatile organic compounds adsorbed by the adsorption filter 130 is increased, the gases containing volatile organic compounds are blocked from being introduced to the body part 110, the absorbed volatile organic compounds are desorbed by irradiating the adsorption filter 130 with microwaves, and air, carbon dioxide, water vapor, etc. are discharged via the outlet 112 by oxidizing desorbed volatile organic compounds via the oxidation filter 150 heated by microwaves.

Referring to FIG. 3, in the present embodiment, the adsorption filter 130 or oxidation filter 150 is made of a material containing silicon carbide (SiC) and is provided with a filter base made of a porous member with a plurality of through holes 123 that are formed in a flow path direction from the inlet 113 to the outlet 115, and heated by microwaves.

Preferably, the filter base 120 has a honeycomb structure having the plurality of through holes 123 that are formed in the direction of the flow path.

Further, the filter base 120 is provided by applying substances for adsorption and oxidation thereon, the adsorption filter 130 is provided by an adsorbent 133 applied on a surface of the filter base 120 having the plurality of through holes 123, and the oxidation filter 150 is provided by an oxidation catalyst 153 applied on the surface of the filter base having the plurality of through holes 123.

Here, the adsorbent 133 and the oxidation catalyst 153 may be selected from activated carbon, zeolite, Al₂O₃, mixed metal oxide, etc.

Meanwhile, in the present embodiment, the adsorption filter 130 and the oxidation filter 150 are formed in a plate shape having a predetermined thickness, and are provided in directions perpendicular to the flow path, and the microwaves are irradiated from sides of the adsorption filter 130 and the oxidation filter 150 in directions parallel to the adsorption filter 130 and the oxidation filter 150, that is to say directions perpendicular to the flow path.

The adsorption filter 130 and the oxidation filter 150 according to the present embodiment in which a contact area between the gases containing volatile organic compounds and the adsorption filter 130 and the oxidation filter 150 is enhanced by the porous member having the plurality of through holes 123. Thus, adsorption efficiency and oxidation efficiency of the filters are improved.

Particularly, the honeycomb structure maximizes improvements of adsorption efficiency and oxidation efficiency of the filters and reduces pressure drop that is caused by the plurality of through holes 123 having intricate paths as the porous member.

Further, for improvements of adsorption efficiency and oxidation efficiency of the filters, there is a need to heat the adsorption filter 130 and the oxidation filter 150 at a predetermined temperature (for example: equal to or greater than 200□). In the case that the filters are composed of Mg or Al in the prior art, desorption and oxidation of the volatile organic compounds by successively arranging the adsorption filter 130 and the oxidation filter 150 were impossible due to a limitation of a heating temperature (about 50□).

The present inventors have confirmed via experiments that the limitation of the heating temperature in the prior art can be solved by manufacturing the filter base 120 having the plurality of through holes 123 by using silicon carbide (SiC) and can be solved by manufacturing the adsorption filter 130 and the oxidation filter 150 by applying the adsorbent or the oxidation catalyst on the surface of the filter base 120 having the plurality of through holes 123.

In other words, the present inventors have confirmed that the filters are needed to be heated to a predetermined temperature by microwaves in a relatively short time to implement the volatile organic compounds removal system using microwaves for energy saving. To this end, the present inventors have achieved using silicon carbide (SiC) as a raw material of the filter base 120. However, other materials may be deemed suitable via trial and error by those skilled in the art.

Furthermore, the present inventors have adopted the honeycomb structure of the filters for reducing pressure drop that is caused by flow of air and therefore desorption and oxidation are efficiently implemented in the body part 110 having a limited structure.

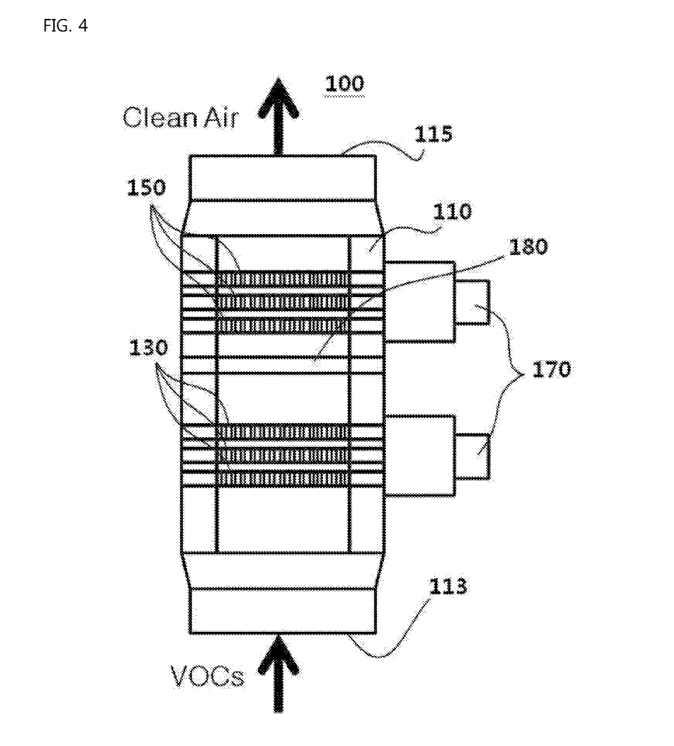

FIG. 4 is a view conceptually showing a modification of FIG. 1.

Referring to FIG. 4, in the first embodiment of the present disclosure described above, the adsorption filter 130 or the oxidation filter 150 is provided as a plurality of filters that are arranged successively at a predetermined interval.

Hereby, adsorption efficiency and oxidation efficiency of the filters can be improved by enhancing the contact area for adsorption and oxidation.

Meanwhile, an insulator 180 is provided between a downstream side of the adsorption filter 130 and an upstream side of the oxidation filter 150 in a direction from the inlet 113 towards the outlet 115.

Hereby, the insulator 180 prevents heat loss from any one of the adsorption filter 130 and the oxidation filter 150 to a remaining one of the filters 130 and 150 or to the outside.

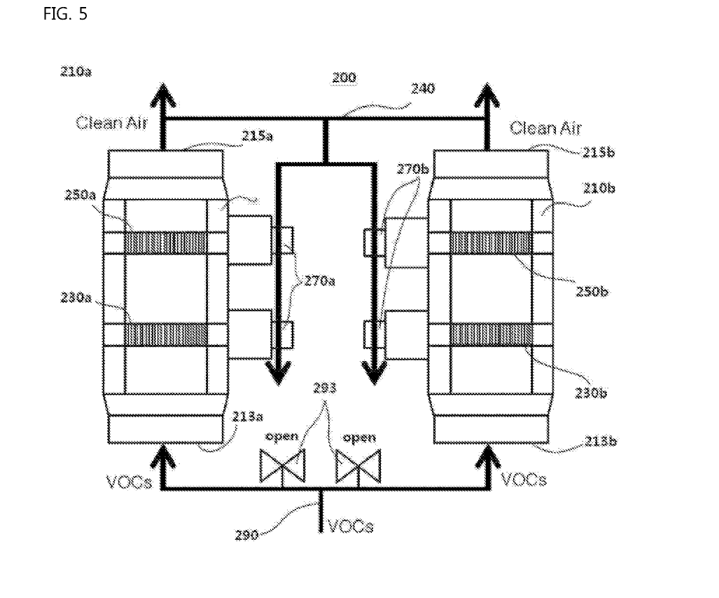

FIGS. 5 to 7 are views showing a second embodiment of a volatile organic compounds removal system using microwaves according to the present disclosure.

First, referring to FIG. 5, the volatile organic compounds removal system 200 using microwaves according to the present embodiment is provided with a plurality of body parts 210a and 210b provided independently of each other.

Each of the plurality of body parts 210a and 210b has a same structure with a body part 110 of a first embodiment. In other words, the plurality of body parts 210a and 210b are respectively provided with inlets 213a and 213b and outlets 215a and 215b, and are respectively provided with adsorption filters 230a and 230b and oxidation filters 250a and 250b. Further, the plurality of body parts 210a and 210b are respectively provided with a plurality of magnetrons 270a and 270b. Configuration of the present embodiment is identical to the first embodiment and the same description is omitted herein.

Meanwhile, the volatile organic compounds removal system 200 using microwaves according to the present embodiment is further provided with a gas supply pipe 290 that selectively supplies gases containing volatile organic compounds to the plurality of body parts 210a and 210b.

Specifically, the gas supply pipe 290 communicates with the inlets 213a and 213b of the plurality of body parts 210a and 210b to distribute gases containing volatile organic compounds to the plurality of body parts 210a and 210b, and has a valve unit 293 to selectively supply the gases containing volatile organic compounds to the body parts 210a and 210b.

Hereby, the plurality of body parts 210a and 210b are provided to enable sequential treatment of the gases containing volatile organic compounds.

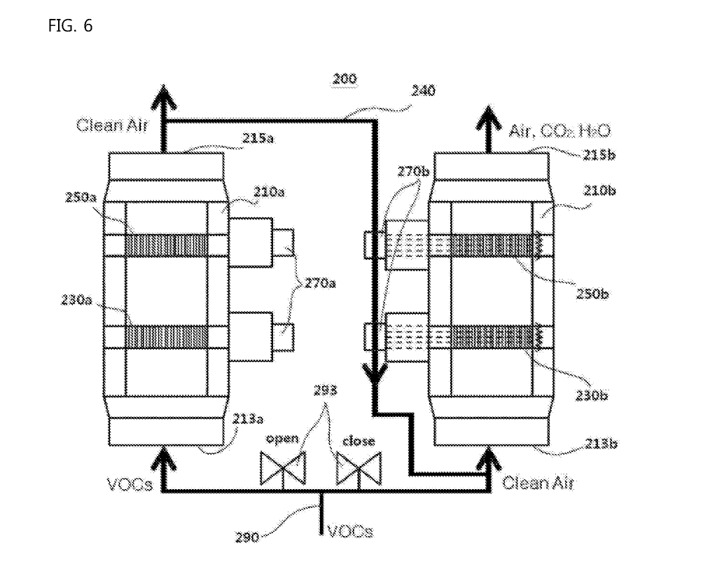

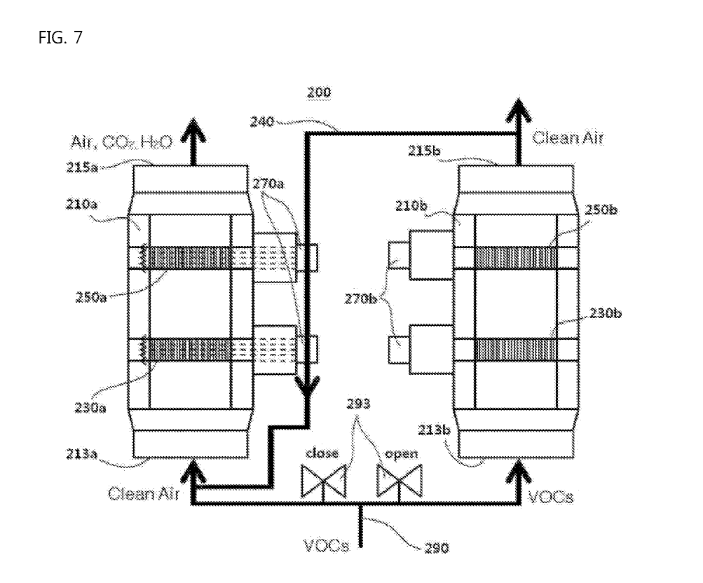

Specifically, as shown in FIG. 5, in the case that desorption and oxidation are not needed for all of the plurality of body parts 210a and 210b, the gases containing volatile organic compounds are supplied to all of the plurality of body parts 210a and 210b to be adsorbed, as shown in FIG. 6, the gases containing volatile organic compounds are supplied only to the remaining body part 210a via the valve unit 293 to be adsorbed while desorption and oxidation are performed in the adsorption filter 230b and oxidation filter 250b of the body part 210b of the plurality of the body parts 210a and 210b, and as shown in FIG. 7, on the other hand, the gases containing volatile organic compounds are supplied only to the body part 210b to be adsorbed while desorption and oxidation are performed in the adsorption filter 230a and oxidation filter 250a of the body part 210a. The processes are sequentially performed, thereby enabling sequential treatment of the gases containing volatile organic compounds.

Hereinafter, operations of the volatile organic removal system 200 using microwaves according to the present embodiment will be described in detail.

In the present embodiment, the valve unit 293 sequentially repeats a first operation (refer to FIG. 5) that supplies gases containing volatile organic compounds to the plurality of first body parts 210a and 210b for a first predetermined time, a second operation (refer to FIG. 6) that supplies gases containing volatile organic compounds to only the first body part 210a of the plurality of body parts 210a and 210b for a second predetermined time, and a third operation (refer to FIG. 7) that supplies gases containing volatile organic compounds to only the second body part 210b of the plurality of body parts 210a and 210b for a third predetermined time.

Here, preferably the second predetermined time and the third predetermined time are equal to or less than 30% of the first predetermined time to maximize energy saving efficiency. According to experiments conducted by the present inventors, when cycling over a period of an hour, the first predetermined time is 40 minutes and each of the second and the third predetermined time is 10 minutes so that satisfactory energy saving efficiency has been obtained.

Meanwhile, in the present embodiment, when a plurality of magnetrons 270b provided in the body part 210b in which gases containing volatile organic compounds avoid being supplied irradiates the filters with microwaves during the second operation, there is a need to cool down the plurality of magnetrons. For this, a bypass tube 240 is provided by using a part of gas discharged from the body part 210a in which gases containing volatile organic compounds are supplied.

Meanwhile, the same principle of operation may be applied to the third operation.

Further, in the present embodiment, the inlets 213a and 213b may be respectively provided in lower parts of the plurality of body parts 210a and 210b in a direction of gravity, and the outlets may be respectively provided in upper parts of the plurality of body parts 210a and 210b in the direction of gravity.

On the other hand, the plurality of the body parts 210a and 210b may be arranged to provide each of the inlets 213a and 213b and the outlets 215a and 215b at a location horizontal to each other.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A volatile organic compound removal system using microwaves, the system comprising:
a first body part having a first inlet and a first outlet, with a flow path formed therein;
a first adsorption filter and a first oxidation filter provided in an interior of the first body part and provided to allow gases flowing in the flow path to pass successively in a direction from the first inlet to the first outlet;
a plurality of first magnetrons provided in a side of the first body part to respectively correspond to the first adsorption filter and the first oxidation filter, and selectively irradiating the first adsorption filter and the first oxidation filter with microwaves;
a second body part provided independently of the first body part, and having a second inlet and a second outlet;
a second adsorption filter and a second oxidation filter provided in an interior of the second body part and provided to allow the gases flowing in the flow path to pass successively in a direction from the second inlet to the second outlet;
a plurality of second magnetrons provided in a side of the second body part to respectively correspond to the second adsorption filter and the second oxidation filter, and selectively irradiating the second adsorption filter and the second oxidation filter with microwaves; and
a gas supply pipe provided to communicate with the first inlet and the second inlet, and having a valve unit that selectively controls gases containing volatile organic compounds to be supplied to the first body part or the second body part.

2. The volatile organic compound removal system of claim 1, wherein at least one of the first and the second adsorption filters and the first and the second oxidation filters is made of a material containing silicon carbide and is provided with a filter base made of a porous member with a plurality of through holes that are formed in a direction of the flow path, and heated by microwaves.

3. The volatile organic compound removal system of claim 2, wherein the filter base has a honeycomb structure having the plurality of through holes that are formed in the direction of the flow path.

4. The volatile organic compound removal system of claim 3, wherein the first and the second adsorption filters are provided by an adsorbent applied on a surface of the filter base having the plurality of through holes.

5. The volatile organic compound removal system of claim 3, wherein the first and the second oxidation filters are provided by an oxidation catalyst applied on a surface of the filter base having the plurality of through holes.

6. The volatile organic compound removal system of claim 4, wherein each of the first and the second adsorption filters and the first and the second oxidation filters is formed in a plate shape having a predetermined thickness, and is provided in a direction perpendicular to the flow path, and the microwaves are irradiated from sides of the first and the second adsorption filters and the first and the second oxidation filters in directions perpendicular to the flow path.

7. The volatile organic compound removal system of claim 6, wherein at least one of the first and the second adsorption filters and the first and the second oxidation filters is provided as a plurality of filters that is arranged successively at a predetermined interval.

8. The volatile organic compound removal system of claim 6, wherein an insulator is provided between a downstream side of the first adsorption filter and an upstream side of the first oxidation filter in a direction from the first inlet towards the first outlet or between a downstream side of the second adsorption filter and an upstream side of the second oxidation filter in a direction from the second inlet towards the second outlet.

9. The volatile organic compound removal system of claim 1, wherein the valve unit sequentially repeats a first operation that supplies gases containing volatile organic compounds to the first body part and the second body part for a first predetermined time, a second operation that supplies gases containing volatile organic compounds to only the first body part for a second predetermined time, and a third operation that supplies gases containing volatile organic compounds to only the second body part for a third predetermined time.

10. The volatile organic compound removal system of claim 9, wherein each of the plurality of second magnetrons irradiates the second adsorption filter and the second oxidation filter with microwaves and a part of air discharged via the first outlet cools down the second magnetrons during the second operation, and each of the plurality of first magnetrons irradiates the first adsorption filter and the first oxidation filter with microwaves and a part of air discharged via the second outlet cools down the first magnetrons during the third operation.

11. The volatile organic compound removal system of claim 9, wherein the second predetermined time and the third predetermined time are equal to or less than 30% of the first predetermined time.

12. The volatile organic compound removal system of claim 1, wherein the first inlet and the second inlet are respectively provided in lower parts of the first body part and the second body part in a direction of gravity, and the first outlet and the second outlet are respectively provided in upper parts of the first body part and the second body part in the direction of gravity.

13. The volatile organic compound removal system of claim 5, wherein each of the first and the second adsorption filters and the first and the second oxidation filters is formed in a plate shape having a predetermined thickness, and is provided in a direction perpendicular to the flow path, and the microwaves are irradiated from sides of the first and the second adsorption filters and the first and the second oxidation filters in directions perpendicular to the flow path.
